(19) United States
(12) Patent Application Publication
(10) Pub. No.: US 2009/0211382 A1
(43) Pub. Date: Aug. 27, 2009

(54) Open Delivery Alarm Testing Apparatus

(75) Inventor: Margaret A. Feiter, Roselle, IL (US)

Correspondence Address: UNGARETTI & HARRIS LLP;INTELLECTUAL PROPERTY GROUP - PATENTS, 70 WEST MADISON STREET, SUITE 3500, CHICAGO, IL, 60602-4224, US

(73) Assignee: HSI FIRE & SAFETY GROUP, LLC, Elk Grove Village, IL (US)

(21) Appl. No.: 12/395,190

(22) Filed: Feb. 27, 2009

Related U.S. Application Data
(60) Provisional application No. 61/031,952, filed on Feb. 27, 2008.

(51) Int. Cl. G01N 19/00

(52) U.S. Cl. 73/865.9; 340/628

(57) ABSTRACT

An open delivery alarm testing apparatus has a first shaft and a spring-loaded activator. The first shaft has a proximal end and a distal end. The spring-loaded activator extends outwardly from the proximal end of the shaft produced. The spring-loaded activator is produced from an insulating material.

### CROSS-REFERENCE TO RELATED APPLICATIONS

This application claims the benefit of U.S. Provisional Application No. 61/031,952, filed on Feb. 27, 2008 and is hereby incorporated by reference as if fully set forth herein

### TECHNICAL FIELD

The invention relates to alarm testing apparatuses. More particularly, the present invention relates to an open delivery smoke alarm testing apparatus.

### BACKGROUND OF THE INVENTION

Smoke detectors and carbon monoxide detectors are now commonly used in homes and schools and industrial and commercial facilities. They are frequently mounted to posts, ceilings or walls to alert an alarm for occupants and visitors when either smoke is detected or elevated levels of carbon monoxide are detected. To test such detectors for service or maintenance, a testing device or test dispenser is used. The prior art testing device for testing smoke or carbon monoxide detectors are often inadequate to reach detectors mounted in high elevated places on walls and ceilings in factories and large office buildings while the operator of the testing device is standing on the ground floor of the factory or office building having the high walls and ceilings.

The testing systems commonly used are either called an “open delivery system” or an “enclosed delivery system.” In an “enclosed delivery system,” the environment around the detector is controlled or enclosed, namely closed to everything but the detector and the testing materials. The testing chamber generally tries to cover the detector being tested so that the testing material may be applied in the chamber (and not the environment surrounding the chamber) to test the detector. Alternatively, in an “open delivery system,” a chamber is not used. Instead, the testing material is applied around the detector's environment, namely the open space around the detector. For many reasons, the enclosed delivery system is required in some environments.

HSI Fire and Safety Group LLC, Elk Grove Village, Ill. sells successful and popular testing devices made in accordance with the present invention under the trademark VERSA-TOOLS™. The VERSA-TOOLS™ kits include an aerosol test dispenser or canister, a telescoping test pole (e.g., 8 feet or 16 feet), an adapter pole for additional reach, and an equipment bag. The poles are durable, lightweight, non-conductive fiberglass.

Some testing materials, provided in aerosol form, include the Smoke Detector Tester™ dispenser or canister which specifically tests both photoelectric and ionization smoke detectors to ensure that the circuitry, alarm and power is functioning and that they are actively sampling the air for any hint of smoke. The patented formulation simulates the entire range of fire conditions giving one the confidence of knowing the fire alarm system will respond promptly to all fire conditions. The Smoke Detector Tester™ Plus, which was designed to be 100% non-flammable for hospitals, clean rooms, etc. and is similar to Smoke Detector Tester™ aerosol. Both of these products are approved for testing smoke detector function per NFPA 72 par. 8-2.4.1 when used as directed.

It is appreciated that other testing materials are available on the market in other forms besides aerosol cans or canisters, etc.

Many prior open delivery test systems provide an elongated metal shaft. The shaft has an actuator extending through a passageway in the center of the shaft. The actuator protrudes from one end of the shaft and has a substantially 90 degree bend to form an arm for actuating release of the contents of an aerosol test canister bend upon a downward force applied to the actuator. The actuator is biased in an upward position by a spring member within the shaft. The force overcomes the spring member bias. This force is generally provided by pressing a portion of the actuator near the 90 degree bend against a firm object, e.g. a wall, ceiling, a portion of the alarm apparatus etc. The aerosol canister is generally attached to the shaft by a clamp near the location where the actuator protrudes from the shaft.

Metal shafts are preferential to shaft of other materials for many reasons. For example, metal shafts tend to be stiffer, thus easier to handle. The stiffness allows the shaft to be extended great distances to ceilings without losing control over the highest end of the shaft near the alarm apparatus. Similarly, metal shafts will not deflect to the degree of some non-metal shafts as pressure is placed against the actuator to release the contents of the aerosol canister.

One significant problem with other prior art testing devices is that alarm apparatuses commonly have external electrical wires to and from them. During an electrical malfunction, these “live” wires can conduct electricity to the metal testing shaft, resulting in serious injury to a person conducting the test. Moreover, the sparks generated by contact between the metal shaft and the live wires could cause catastrophic failure of the aerosol canister, which, again, could result in injury to the user.

The present invention is provided to solve the problems discussed above and other problems, and to provide advantages and aspects not provided by prior open delivery alarm testing apparatuses of this type. A full discussion of the features and advantages of the present invention is deferred to the following detailed description, which proceeds with reference to the accompanying drawings.

### SUMMARY OF THE INVENTION

One aspect of the present invention is directed to an adaptor for an open delivery alarm testing apparatus. The adaptor comprises a shaft. The shaft has a distal end including means for attaching the shaft to the open delivery alarm testing apparatus, a proximal end, and an activator extending outwardly therefrom. The activator includes a first portion joined to the shaft and spring-loaded relative thereto, an exposed second portion, and an extension member extending outwardly from the second portion and substantially perpendicular. The second portion is spring-biased in an upward position. The adaptor is at least partially produced from an electrically insulating material to prevent an electric current from being transferred from the adaptor to remaining portions of the open delivery alarm testing apparatus.

The adaptor may include one or more of the following additional features either alone or in combination. The first portion of the activator may be enclosed within the shaft and engaged by a spring member within the shaft to provide and an upward bias to the extension member. The extension member may be produced from a rigid insulating material. The adaptor may further comprise a bracket fixedly attached to the shaft for attaching a canister to the adaptor. The distal end of the shaft may have a circumference less than a circumference of the proximal end of the shaft. A circumferential shoulder may separate the distal end of the shaft from the proximal end of the shaft. The circumferential shoulder may include a planar abutment. The means for attaching the shaft to the open delivery alarm testing apparatus may include a spring-loaded keeper extending radially outwardly from the distal end of the shaft through an aperture in the shaft, a portion of the keeper retained within the shaft.

Another aspect of the present invention is directed to an open delivery alarm testing apparatus comprising a lower shaft, an upper shaft, a spring-loaded activator, a bracket, and a testing canister. The elongated lower shaft is produced from a rigid polymeric material and positioned about a longitudinal axis. It has a first end and a second end having an opening. The lower shaft has an overall length greater than 24 inches (61 cm). The upper shaft is also produced from a rigid insulating material and has a shorter length than the lower shaft. The upper shaft has a distal end and a proximal end. The distal end has a smaller cross-sectional area than an adjacent portion of the upper shaft such that an abutment is formed between the distal end and the adjacent portion. The distal end fits within the opening in the second end of the lower shaft such that the abutment engages the lower shaft. The upper shaft is joined to the lower shaft by an attachment means including a spring-loaded keeper extending radially outwardly from the distal end of the upper shaft and engages a portion of the lower shaft to retain the upper shaft to the lower shaft. The spring-loaded activator is produced from a rigid insulating material and extends from the proximal end of the upper shaft. The activator has a rod inserted within the proximal end of the lower shaft and extends outwardly therefrom. The activator also has a beam member extending outwardly from the rod substantially perpendicular to the longitudinal axis and biased in an upward position by a spring member. The bracket is fixedly attached to the upper shaft for attaching a container thereto. A testing container is attached to the upper shaft by the bracket and filled with a testing substance stored under pressure within the testing container. The testing container has a pressure relief valve positioned by the bracket so that it is proximate a lower surface of the beam member of the spring-loaded activator and engageable therewith on a downward force placed on an opposing upper surface of the activator.

Another aspect of the present invention is directed to an open delivery alarm testing apparatus comprising a first shaft and a spring-loaded activator. The first shaft has a proximal end and a distal end. The spring-loaded activator extends outwardly from the proximal end of the shaft. At least a portion of activator is produced from an insulating material.

The open delivery alarm testing apparatus of this aspect of the invention may include one or more of the following features, alone or in combination. It may further comprise a means for attaching the first shaft to a second shaft which has an opening for receiving at least a portion of the distal end of the first shaft. The spring-loaded activator may comprise a rod having a first portion housed within the first shaft and an exposed second portion extending outwardly from an aperture in the proximal end of the first shaft. The spring-loaded activator may also comprise an extension member extending outwardly from the exposed second portion of the rod. The extension member may be substantially perpendicular to the rod. The second shaft may have a length greater than a length of the first shaft. The distal end of the first shaft may have a diameter less than a diameter of the proximal end of the first shaft wherein the distal end and proximal end may be separated by a shoulder portion having an abutment. A portion of the first end of the second shaft may abut the abutment of the first shaft. The means for attaching the first shaft to the second shaft may comprise a spring-loaded keeper extending outwardly from a circumferential sidewall of the distal end of the first shaft to fit with an aperture in a sidewall of the second shaft. A bracket may be fixedly attached to the first shaft and adapted for retaining a test canister to the first shaft.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of an open delivery alarm testing apparatus of the present invention;

FIG. 2 is an exploded view of the open delivery alarm testing apparatus of FIG. 1 with the bracket for attaching a canister to the apparatus removed;

FIG. 3 is a perspective view of an adaptor for use with an open delivery alarm testing apparatus;

FIG. 4 is a cross-sectional view of the adaptor of FIG. 3 with a spring element compressed such that an activator is in a lower position; and

FIG. 5 is a perspective view of the adaptor of FIG. 3 with a bracket attached to the adaptor and a test canister held thereto.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

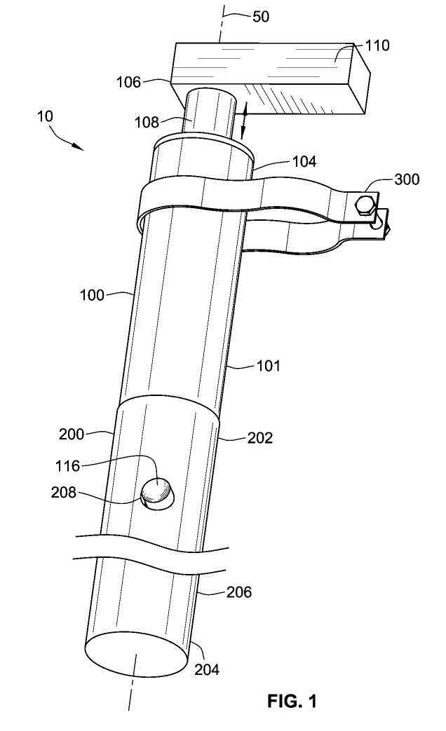

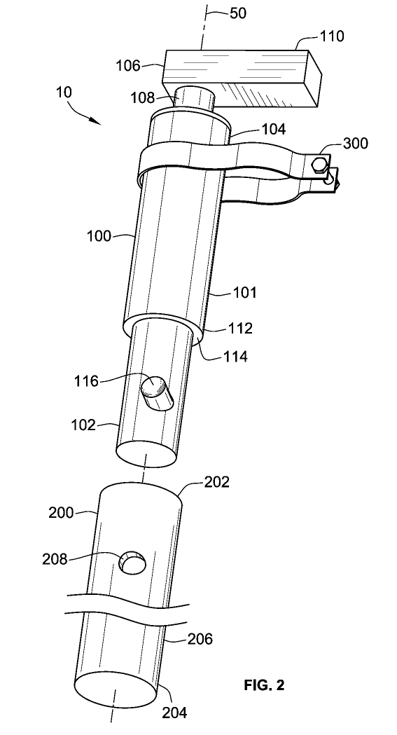

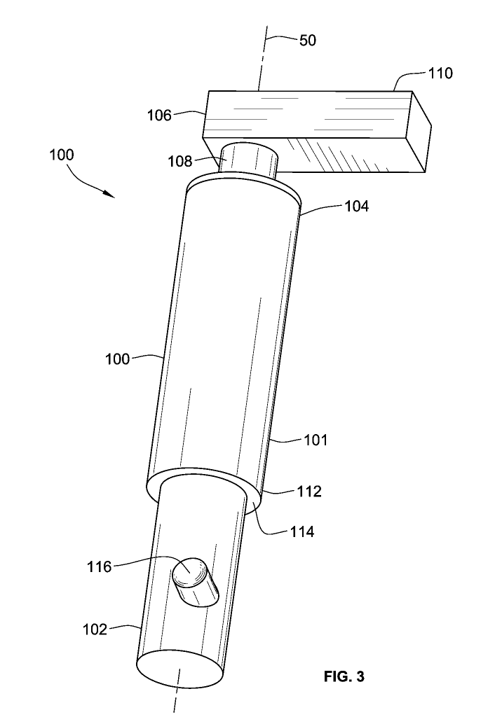

Referring to FIGS. 1-5, an open delivery alarm testing apparatus 10 positioned about a longitudinal axis 50 is illustrated. The general object of devices of this type is well-known in the art of smoke/fire/carbon monoxide alarm testing. Simply, the apparatus provides an extension by which a user may reach an alarm device located high on a wall and activate a canister of smoke, gas, dust under pressure. When activated, the canister releases the pressurized contents adjacent the alarm to test the operability of the alarm. The present invention provides many advantages over prior art apparatuses of this type. As shown, the open delivery alarm testing apparatus of the present invention includes an upper shaft or adaptor 100 attached to a much longer, elongated lower shaft 200.

The adaptor 100 is generally produced from an insulating material, preferably a rigid polymeric material or a fiberglass. The adaptor 100 includes a cylindrical tube 101 having a distal end 102 and a proximal end 104. A spring-loaded activator 106 extends upwardly from the proximal end along the longitudinal axis 50.

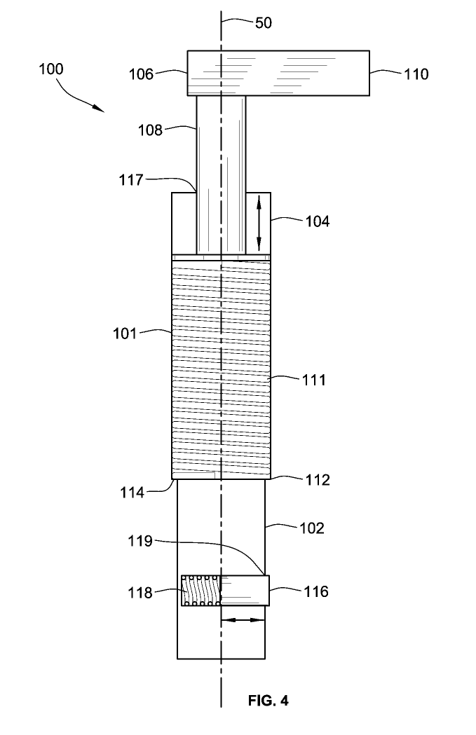

The activator 106 includes an elongated rod 108 attached to an extension member 110. The elongated rod 108 is partially concealed within the cylindrical tube 101. A spring loading element 111 is located within the tube 101 to provide the necessary resistance force to the activator 106. The spring-loading is biased upwardly such that the activator 106 is normally in an elevated position. As the spring element 111 is compressed by a downward force on the extension member 110 the activator 106 moves into a lower position. This activator 106 movement is shown by the arrows in FIG. 4.

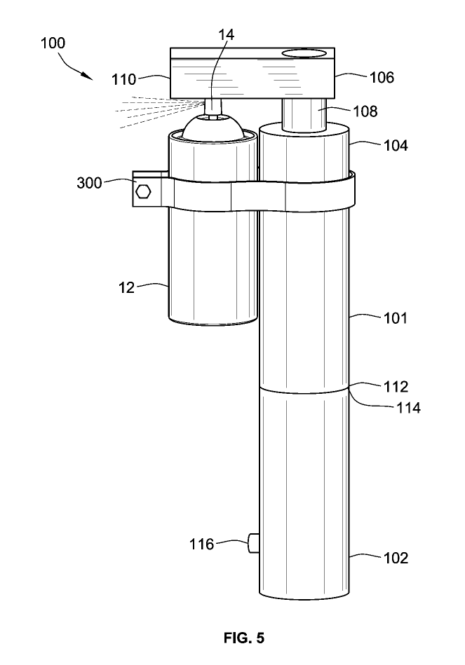

The extension or beam member 110 extends generally outwardly from an exposed end of the rod 108. The extension is at an angle to the rod, preferably substantially perpendicular to the longitudinal axis 50. Here, the modifying word “substantially” is intended to encompass any angle wherein the extension member 110 can engage and activate a spray element on a canister when the activator 106 is forced downwardly against the force of the spring element 111. (See FIG. 5).

The cylindrical tube 101 defines a housing in which a portion of the activator 106 rod 108 is located and traverses. The distal end 102 of the cylindrical tube 101 has a cross-sectional area or diameter less than a cross-sectional area or diameter of the proximal end 104. A shoulder 112 separates the distal end 102 from the proximal end 104 and includes an abutment 116, preferably having a planar surface, the purposed of which will be explained in more detail below.

The proximal end 104 of the tube 101 has an aperture 117 through which the rod 108 emerges from the housing. The aperture 117 may be adapted, as in sized and shaped, to guide the rod 108 through proper motion.

The distal end 102 of the tube 101 includes means for attaching the adaptor 100 to the elongated shaft 200. This means for attachment includes a spring-loaded keeper 116 projecting outwardly from a circumferential sidewall of the tube 101. Accordingly, another spring element 118 biases the keeper 116 outwardly through another aperture 119 in the tube 101.

An adjustable bracket 300 as shown in FIGS. 1 and 5 is fixedly attached to the proximal end 104 of the adaptor 100. Any type of attachment means may be provided, but the preferable means includes a plurality of screws. The bracket 300 is used to attach a canister 12 of smoke, gas, dust, etc. under pressure to the adaptor 300 and to position a pressure relief valve 14 on the canister 12 proximate the beam member 110 such that the beam member 110 may activate the pressure relief valve 14 upon compression of the spring element 111 to release the contents of the canister 12 at a desired time in a desired location. (See FIG. 5).

The elongated shaft 200 is also produced from a rigid metallic material or a rigid insulating material, preferably polymeric or fiberglass material. This shaft 200 is generally tubular in structure having opposing ends 202,204 joined by a cylindrical sidewall 206 and can be several feet in length with the capability of attaching further similar elongated shafts to grow even longer. One end 202 includes an aperture for receiving the distal end 102 of the adaptor 100. A rim portion of the end 202 abuts the abutment 116 between the distal and proximal ends 102,104 of the adaptor. An opening or aperture 208 in the sidewall 206 is adapted, as in sized and shaped, to receive the keeper 116 to retain the adaptor 100 to the lower shaft 200. Other mechanisms for attaching the adaptor 100 to the shaft 200 are readily available, such as threaded connectors, tongue and groove, hook and latch, friction fitting, etc.

The open delivery alarm testing apparatus described above has many advantages over prior art open delivery alarm testing apparatuses of the prior art. First, the non-conductive portion or portions of the adaptor protect the user from electrical shock. Secondly, the apparatus of the present invention is lighter in weight and easier to handle. Thirdly, the adaptor is separately replaceable; therefore, if one of the elongated shaft or the adaptor fails, only one of the components must be replaced.

One of ordinary skill in the art would appreciate that the terms “first,” “second,” “upper,” “lower,” etc. are used for illustrative purposes only and are not intended to limit the embodiments in any way. The term “plurality” as used herein is intended to indicate any number greater than one, either disjunctively or conjunctively as necessary, up to an infinite number. The terms “joined” and/or “connected” as used herein are intended to put or bring two elements together so as to form a unit, and any number of elements, devices, fasteners, etc. may be provided between the joined or connected elements unless otherwise specified by the use of the term “directly” and/or supported by the drawings.

While the specific embodiments have been illustrated and described, numerous modifications come to mind without significantly departing from the spirit of the invention, and the scope of protection is only limited by the scope of the accompanying Claims.

What is claimed is:

1. An adaptor for an open delivery alarm testing apparatus, the adaptor comprising:
a shaft having a distal end having means for attaching the shaft to the open delivery alarm testing apparatus, a proximal end, and an activator extending outwardly therefrom, the activator having a first portion joined to the shaft and spring-loaded relative thereto, an exposed second portion, and an extension member extending outwardly from the second portion and substantially perpendicular and spring-biased in an upward position wherein the adaptor is at least partially produced from an electrically insulating material to prevent an electric current from being transferred from the adaptor to remaining portions of the open delivery alarm testing apparatus.

2. The adaptor of claim 1 wherein the first portion of the activator is enclosed within the shaft and is engaged by a spring member within the shaft to provide and an upward bias to the extension member.

3. The adaptor of claim 2 wherein the extension member is produced from a rigid insulating material.

4. The adaptor of claim 3 further comprising:
a bracket fixedly attached to the shaft for attaching a canister to the adaptor.

5. The adaptor of claim 4 wherein the distal end of the shaft has a circumference less than a circumference of the proximal end of the shaft.

6. The adaptor of claim 5 wherein a circumferential shoulder separates the distal end of the shaft from the proximal end of the shaft.

7. The adaptor of claim 6 wherein the shoulder includes a planar abutment.

8. The adaptor of claim 7 wherein the means for attaching the shaft to the open delivery alarm testing apparatus includes a spring-loaded keeper extending radially outwardly from the distal end of the shaft through an aperture in the shaft, a portion of the keeper retained within the shaft.

9. An open delivery alarm testing apparatus comprising:
an elongated lower shaft produced from a rigid polymeric material positioned about a longitudinal axis and having a first end and a second end having an opening, the elongated lower shaft having an overall length greater than 24 inches (61 cm);
an upper shaft produced from a rigid insulating material having a shorter length than the lower shaft, the upper shaft having a distal end and a proximal end, the distal end having a smaller cross-sectional area than an adjacent portion of the upper shaft such that an abutment is formed between the distal end and the adjacent portion, the distal end fit within the opening in the second end of the lower shaft such that the abutment engages the lower shaft and is joined to the lower shaft by an attachment means including a spring-loaded keeper extending radially outwardly from the distal end of the upper shaft and engaging a portion of the lower shaft to retain the upper shaft to the lower shaft;
a spring-loaded activator produced from a rigid insulating material extending from the proximal end of the upper shaft, the activator having a rod inserted within the proximal end of the lower shaft and extending outwardly therefrom and a beam member extending outwardly from the rod substantially perpendicular to the longitudinal axis biased in an upward position by a spring member;
a bracket fixedly attached to the upper shaft for attaching a container thereto; and
a testing container attached to the upper shaft by the bracket and filled with a testing substance stored under pressure within the testing container, the testing container having a pressure relief valve positioned by the bracket proximate a lower surface of the beam member of the spring-loaded activator and engageable therewith on a downward force placed on an opposing upper surface of the activator.

10. An open delivery alarm testing apparatus comprising:
a first shaft having a proximal end and a distal end;
a spring-loaded activator extending outwardly from the proximal end of the shaft wherein a portion of activator is produced from an insulating material.

11. The open delivery alarm testing apparatus of claim 10 wherein the first shaft is produced from an insulating material.

12. The open delivery alarm testing apparatus of claim 11 further comprising:
a means for attaching the first shaft to a second shaft having an opening for receiving at least a portion of the distal end of the first shaft.

13. The open delivery alarm testing apparatus of claim 12 wherein the spring-loaded activator comprises:
a rod having a first portion housed within the first shaft and an exposed second portion extending outwardly from an aperture in the proximal end of the first shaft.

14. The open delivery alarm testing apparatus of claim 13 wherein the spring-loaded activator further comprises:
an extension member extending outwardly from the exposed second portion of the rod.

15. The open delivery alarm testing apparatus of claim 14 wherein the extension member is substantially perpendicular to the rod.

16. The open delivery alarm testing apparatus of claim 15 further comprising:
an elongated second shaft having a length greater than a length of the first shaft wherein a first end of the second shaft has an aperture sized and shaped to receive at least a portion of the distal end of the first shaft therein.

17. The open delivery alarm testing apparatus of claim 16 wherein the distal end of the first shaft has a diameter less than a diameter of the proximal end of the first shaft, the distal end and proximal end separated by a shoulder portion having an abutment.

18. The open delivery alarm testing apparatus of claim 17 wherein a portion of the first end of the second shaft abuts the abutment of the first shaft.

19. The open delivery alarm testing apparatus of claim 18 wherein the means for attaching the first shaft to a second shaft comprises:
a spring-loaded keeper extending outwardly from a circumferential sidewall of the distal end of the first shaft to fit with an aperture in a sidewall of the second shaft.

20. The open delivery alarm testing apparatus of claim 19 further comprising:
a bracket fixedly attached to the first shaft adapted for retaining a test canister to the first shaft.
